(19) United States
(12) Patent Application Publication
(10) Pub. No.: US 2013/0271473 A1
(43) Pub. Date: Oct. 17, 2013

(54) Creation of Properties for Spans within a Timeline for an Animation

(71) Applicant: Jonathan M. Duran, Benicia, CA (US)

(72) Inventor: Jonathan M. Duran, Benicia, CA (US)

(73) Assignee: Motorola Mobility, Inc., Libertyville, IL (US)

(21) Appl. No.: 13/445,539

(22) Filed: Apr. 12, 2012

(51) Int. Cl. G06T 13/00

(52) U.S. Cl. 345/473

(57) ABSTRACT

In one embodiment, a method includes receiving an input specifying a keyframe in a first layer included in a master layer to create an animation of a first element in a plurality of elements. The first layer is associated with the first element. A master duration associated with the master layer is determined where the master duration is applied to the plurality of elements. The method determines a keyframe value for the first layer based on the master duration and a property value for the keyframe value for the first layer. Software code is generated specifying the calculated keyframe value and the determined property value, the software code for use in creating the animation of the first element.

### BACKGROUND

To create an animation, a user could manually write software code in hypertext transfer language (HTML) and cascade style sheets (CSS) to create the animation. Manually writing code, however, may be tedious. Authoring applications are provided to allow a user to visually create animations in a user interface. These authoring applications create corresponding HTML and CSS code. However, to execute the HTML and CSS code in a web browser, another software language, such as JavaScript™, is generated to support the animation.

The JavaScript™ code may be used because of the way a web browser interprets HTML and CSS software code. For example, if a user creates animations of three elements where each element has a duration of five seconds and should run consecutively one after another, the web browser would play the animations of all three elements once the web page is loaded instead of consecutively. To avoid the web page playing all of the elements at once, the JavaScript™ code is used to cause the web browser to display each element in series for 5 seconds each.

The use of the authoring application and JavaScript™ code to support the created animation allows a user to more easily create animations that work as intended. However, because another software language is used to support the animation, if a user wants to edit the HTML and CSS code, the editing becomes complicated because the JavaScript™ code may also have to be edited.

### SUMMARY

In one embodiment, a method includes receiving an input specifying a keyframe in a first layer included in a master layer to create an animation of a first element in a plurality of elements. The first layer is associated with the first element. A master duration associated with the master layer is determined where the master duration is applied to the plurality of elements. The method determines a keyframe value for the first layer based on the master duration and a property value for the keyframe value for the first layer. Software code is generated specifying the calculated keyframe value and the determined property value, the software code for use in creating the animation of the first element.

In one embodiment, a non-transitory computer-readable storage medium is provided containing instructions for controlling a computer system to be operable to: receive an input specifying a keyframe in a first layer included in a master layer to create an animation of a first element in a plurality of elements, the first layer being associated with the first element; determine a master duration associated with the master layer, the master duration being applied to the plurality of elements; determine a keyframe value for the first layer based on the master duration; determine a property value for the keyframe value for the first layer; and generate software code specifying the calculated keyframe value and the determined property value for use in creating the animation of the first element.

In one embodiment, an apparatus is provided comprising: one or more computer processors; and a computer-readable storage medium comprising instructions for controlling the one or more computer processors to be operable to: receive an input specifying a keyframe in a first layer included in a master layer to create an animation of a first element in a plurality of elements, the first layer being associated with the first element; determine a master duration associated with the master layer, the master duration being applied to the plurality of elements; determine a keyframe value for the first layer based on the master duration; determine a property value for the keyframe value for the first layer; and generate software code specifying the calculated keyframe value and the determined property value for use in creating the animation of the first element.

The following detailed description and accompanying drawings provide a more detailed understanding of the nature and advantages of the present invention.

### BRIEF DESCRIPTION OF THE DRAWINGS

FIG. 1 depicts an example of a computing device for creating animations according to one embodiment.

FIG. 2 shows an example of generating CSS code according to one embodiment.

FIG. 3 shows a more detailed example of a timeline according to one embodiment.

FIG. 4 depicts a simplified flowchart of a method for creating CSS code for an animation according to one embodiment.

FIG. 5 depicts a simplified flowchart of a method for visually indicating property holds according to one embodiment.

### DETAILED DESCRIPTION

Described herein are techniques for animation system. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

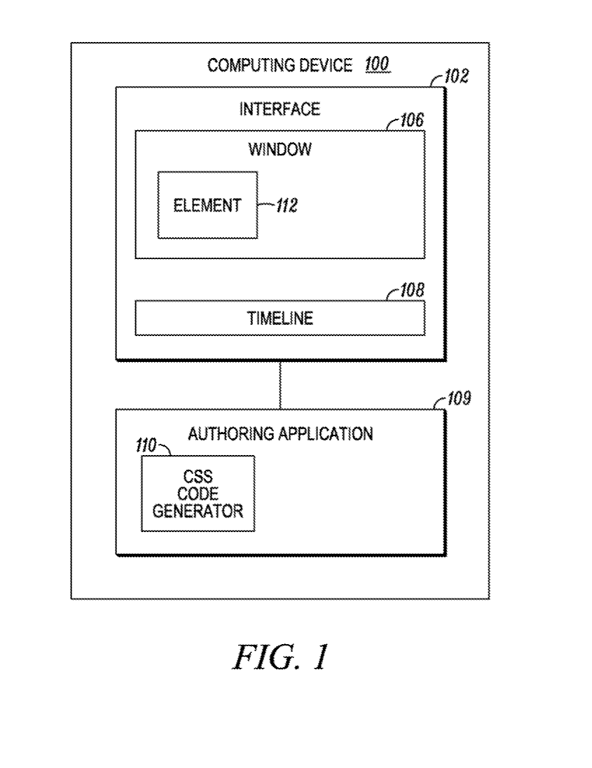

FIG. 1 depicts an example of a computing device 100 for creating animations according to one embodiment. Computing device 100 includes an interface 102 and an authoring application 109 that are used to visually create an animation. Authoring application 109 may be included in computing device 100 or the functions of authoring application 109 may be distributed, such as on a server (not shown) communicating with computing device 100.

An element 112 may be created in an animation window 106. A user may then use an authoring application 109 to create an animation by setting properties of element 112 and selecting a time on a timeline 108. The selected time is referred to as a “keyframe”. The keyframe is one frame in the created animation and is associated with a set of property values.

Element 112 may be various shapes, text, or other objects that can be animated. Element 112 may be associated with a software language, such as an HTML. The animation is created by manipulating different properties of element 112. For example, the position of element 112 may be changed in the animation. In other examples, the color, the shape, or other properties, are changed to create the animation.

During creation of the animation, authoring application 109 receives user input setting a value for a property associated with element 112. For example, element 112 may be moved to a position in window 106. Then, authoring application 109 receives a user input on timeline 108 indicating a time in which the value associated with element 112 should be applied in the animation. Then, authoring application 109 creates a keyframe that is associated with the value. In one example, the animation may move element 112 across window 106 during a time duration, such as 10 seconds. A user can set the position at certain times during the animation by creating keyframes. As the user sets keyframes, authoring application 109 creates software code defining the property values for the keyframes. For example, CSS code may be created for element 112.

A CSS code generator 110 receives the user input creating the animation and generates software code to provide the animation. For example, HTML software code and corresponding CSS software code are created based on the user input. In one embodiment, the HTML software code and CSS software code are created such that a web browser can directly execute the HTML code and the CSS code without other code that needs to be generated to support the animation, such as JavaScript™ Although HTML and CSS software code are referred to for discussion purposes, other types of software code may be used to create the animation.

In one embodiment, a user may wish to create an animation in which a property of the element may not change for a span between keyframes. For example, a user may want to delay the start of the animation to start for 5 seconds after a web page is loaded. Conventionally, JavaScript™ would be used to perform this delay in the animation. However, particular embodiments are creating CSS code directly and thus provide a property hold where the property values for the element do not change for a span between keyframes. For example, in an animation when three elements 112-1, 112-2, and 112-3 are being animated, the animation for second element 112-2 may begin after five seconds. For the 0-5 seconds span, the property value is held. For example, a position of second element 112-2 remains the same. After the five seconds, the animation starts by changing the value of the property.

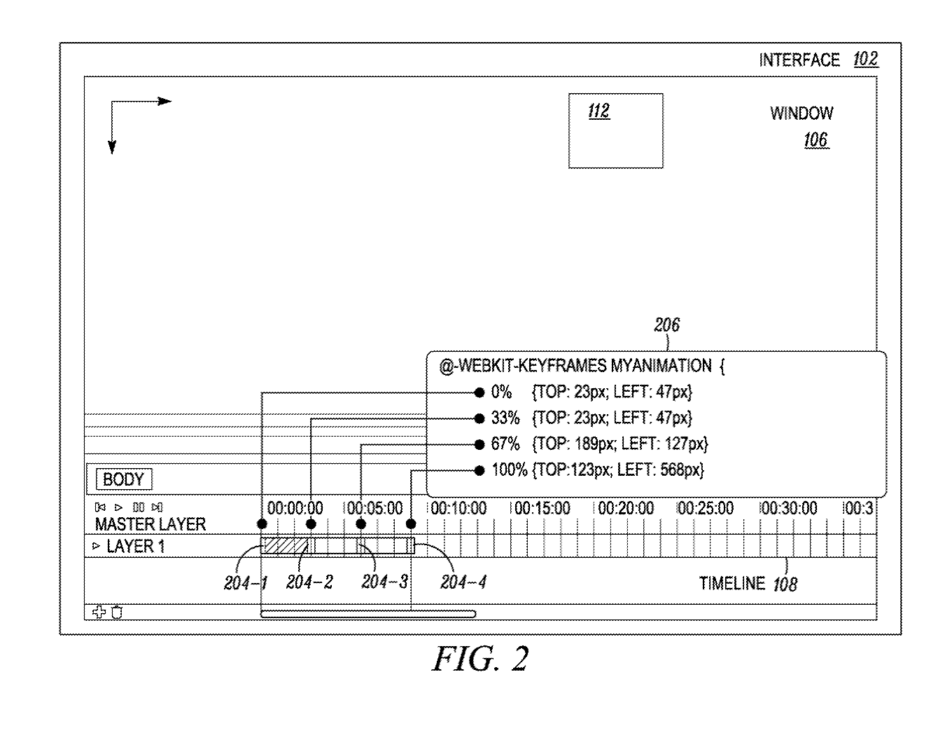

To illustrate the concept of the property hold, FIG. 2 shows an example of generating CSS code according to one embodiment. An animation is created for multiple elements; however, FIG. 2 shows an animation that is created for a single element 112 for discussion purposes. A user may select keyframes 204 to create the animation. For example, as described above, a user may move element 112 to different positions in window 106 and select a keyframe 204 on timeline 108. When keyframe 204 is selected, the position values are noted for element 112. In the animation that the user wants to create as shown, a six second animation should be performed. However, the user does not want the animation to start at zero seconds, but rather at 3 seconds.

At 206, CSS code that is generated based on the user input is shown. It is noted that the CSS code is shown for illustrative purposes and may not be displayed in interface 102. Keyframes at 0%, 33%, 67%, and 100% correspond to keyframes 204-1, 204-2, 204-3, and 204-4, respectively. Each keyframe 204 is associated with property values. For example, the position in pixels of element 112 at each keyframe 204 is stored.

To create the CSS code, CSS code generator 110 applies a master duration to the animation of element 112. For example, the master duration may be 9 seconds in this case. The master duration may be applied to multiple elements 112 that are part of the animation. For discussion purposes, only one element 112 has been created, but an animation with multiple elements 112 will be described in more detail below. Because a user wants the animation to start after 3 seconds, the CSS code created includes a property hold between the 0% keyframe 204-1 and the 33% keyframe 204-2. The CSS code represents the property hold by keeping the property values the same for the 0% keyframe 204-1 and the 33% keyframe 204-2. The property hold is also represented visually in timeline 108 in the span between keyframes 204-1 and 204-2. For example, as shown, diagonal lines have been shaded into the span. Other visual aids may also be used, such as coloring the span with an opaque color, a different color, or other patterns.

If this animation was created without taking into account the master duration, then keyframes 204 that were created and the corresponding CSS code would be:

0% {top: 23px; left: 47px}
50% {top: 189px; left: 127px}
100% {top: 123px; left: 568px}
Conventionally, when a web browser loads a web page, the CSS code would be executed and animation would play immediately. To delay the execution, conventionally, JavaScript™ code would also be generated to execute this code for the animation after three seconds.

By applying the master duration, particular embodiments generate the CSS code to apply a property hold to the animation in the CSS code. This allows direct creation of CSS code that can be executed without having another code to support the CSS code. Thus, even though the animation is six seconds long and starts at the three second mark, applying the master duration makes the animation nine seconds long with the property hold.

The above example is now further described using multiple layers and multiple elements that are animated in a master animation.

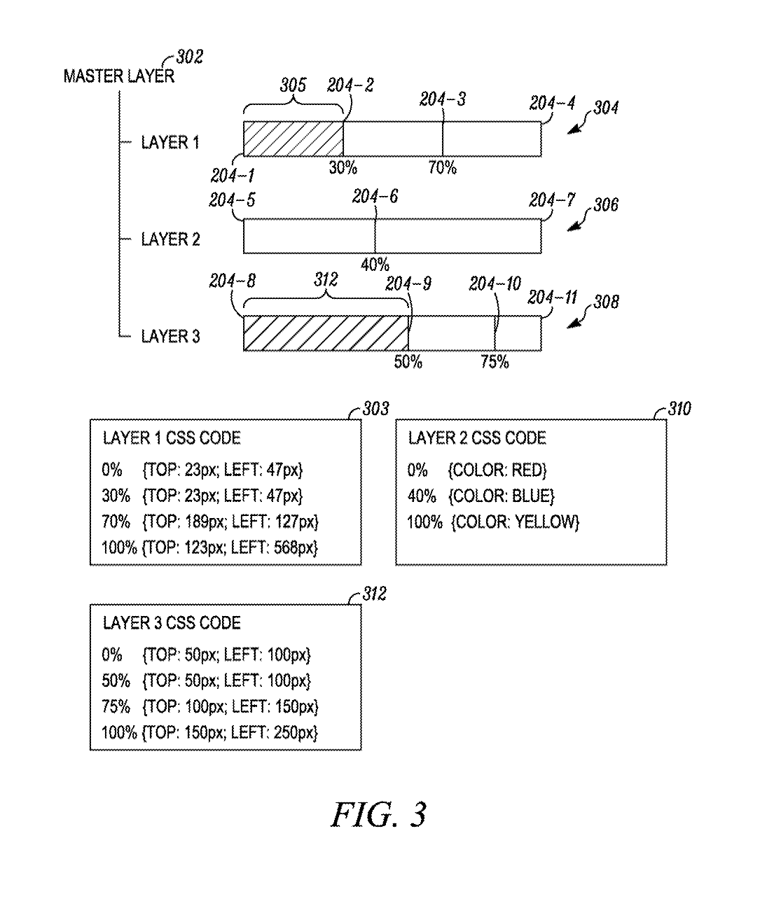

FIG. 3 shows a more detailed example of timeline 108 according to one embodiment. A master layer 302 may include multiple layers. In one embodiment, each layer is associated with an animation of a single element 112. However, it is possible that multiple elements 112 may be animated using a single layer. The animation of each element 112 may last for a duration.

A master duration is associated with multiple layers. For example, the master duration is associated with the master layer, which encompasses layers 1-3. In one example, the master duration may be based on a longest duration for one of the layers. In another example, the master duration may be specified and not be the same as the longest for any of the layers.

At 304, an animation for a first element 112 is shown. This animation lasts 7 seconds, but starts after 3 seconds. The master duration in this case is 10 seconds. Keyframes 204-1-204-4 are defined. Also, a property hold is shown between keyframe 204-1 and keyframe 204-2 at 305. The animation may move element 112-1 to different positions. An example of CSS code for this animation is shown at 303.

At 306, a second element 112-2 is associated with a layer 2. This animation lasts for 10 seconds. For layer 2, keyframes 204-5, 204-6, and 204-7 may be defined. In one embodiment, element 112-2 may be a background color that is changed at certain times. For example, a user may wish the background to change from a red color to a blue color to a yellow color. The corresponding CSS code is shown at 310. For the 0% keyframe, the color value is red, for the 40% keyframe, the color value is blue, and for the 100% keyframe, the color value is yellow. The animation is for the whole duration and thus a property hold is not used.

At 308, a layer 3 is associated with an animation of an element 112-3. This animation lasts 5 seconds, but the start is delayed 5 seconds after the starting point. For layer 3, the user may create an animation for moving a circle element 112-3. Keyframes 204-8-204-11 may be created to define the animation. The user, however, does not want the animation to start until 5 seconds into the master duration. Thus, a property hold is shown at 312. The CSS code that is created based on the master duration includes the property hold. For example, the 0% keyframe 204-8 and the 50% keyframe 204-9 include the same property values as shown at 314. The 75% keyframe 204-10 and the 100% keyframe 204-11 include different values to capture the movement of the element 112-3.

Accordingly, the animations of the three elements 112-1, 112-2, and 112-3 have CSS code generated based on a master duration that is applied to all elements 112-1-112-3. By using the master duration, authoring application 109 generates CSS code that represents each element's animation within the master duration. Other code to support the animation is not needed.

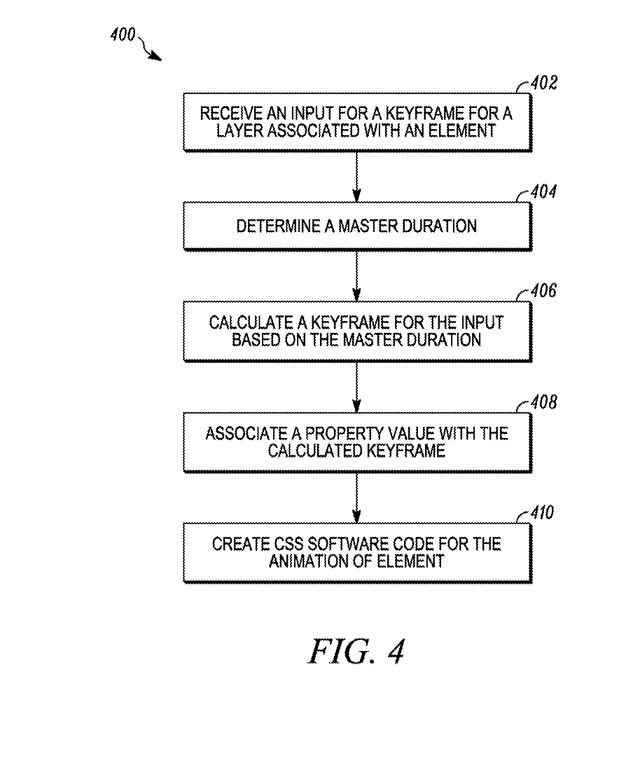

FIG. 4 depicts a simplified flowchart 400 of a method for creating CSS code for an animation according to one embodiment. At 402, CSS code generator 110 receives an input for a keyframe 204 for a layer associated with an element 112. For example, a user may move element 112 in window 106 to a position and then select a keyframe 204 in timeline 108.

At 404, CSS code generator 110 determines a master duration. For example, a master duration is associated with master layer 302.

At 406, CSS code generator 110 calculates a keyframe 204 for the input based on the master duration. For example, a time value, such as a percentage, for keyframe 202 within the master duration is calculated.

At 408, CSS code generator 110 associates a property value with the calculated keyframe 204. For example, a position (e.g., pixel value) in window 106 for element 112 is recorded.

At 410, CSS code generator 110 creates CSS software code for the animation of element 112. In one embodiment, the CSS code may be generated dynamically as a user is creating the animation. Thus, as keyframes 204 are selected, the CSS code is dynamically generated or altered. In other embodiments, the CSS code may be generated after a user has finished creating the animation and selects an input that causes authoring application 109 to generate the CSS code.

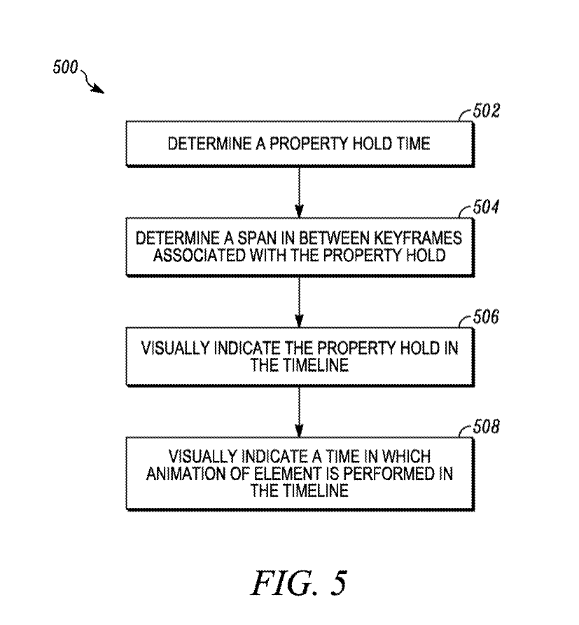

As discussed above, visual indicators may be used to indicate property holds. FIG. 5 depicts a simplified flowchart 500 of a method for visually indicating property holds according to one embodiment. At 502, authoring application 109 determines a property hold time. For example, a user may indicate that a property should be held for a certain span between keyframes 204. In other embodiments, the property hold may be automatically determined based on the user's input and selection of keyframes 204. For example, a user may select multiple keyframes 204 without changing the properties of element 112.

At 504, authoring application 109 determines a span in between keyframes 204 associated with the property hold. The span for a property hold is any span in between keyframes 204 in which the property values do not change.

At 506, authoring application 109 visually indicates the property hold in timeline 108. As discussed above, the indication may be different shading, colors, or patterns.

At 508, authoring application 109 visually indicates a time in which animation of element 112 is performed in timeline 108. The animation may be indicated by a different shading, color, or pattern from the indication used for the property hold.

Accordingly, particular embodiments allow creation of CSS code for an animation. Use of a master duration allows the CSS code to be directly created and executed by a browser. Additional software code may not be needed to perform the animation because the master duration is used.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
receiving an input specifying a keyframe in a first layer included in a master layer to create an animation of a first element in a plurality of elements, the first layer being associated with the first element;
determining a master duration associated with the master layer, the master duration being applied to the plurality of elements;
determining, by a computing device, a keyframe value for the first layer based on the master duration;
determining, by the computing device, a property value for the keyframe value for the first layer; and
generating, by the computing device, software code specifying the calculated keyframe value and the determined property value for use in creating the animation of the first element.

2. The method of claim 1, further comprising holding the property value constant between a span of two keyframes in the first layer.

3. The method of claim 2, wherein holding the property value constant comprises:
associating the property value with the keyframe in the two keyframes in the software code for creating the animation of the first element; and
associating the property value with the another keyframe in the two keyframes in the software code for creating the animation of the first element.

4. The method of claim 2, further comprising displaying a visual indication for the span that the property value is being held constant between the two keyframes.

5. The method of claim 2, wherein:
the animation of the first element is for a first duration,
the holding of the property value is for a second duration, and
the first duration and the second duration equal the master duration.

6. The method of claim 2, wherein holding the property value constant simulates a delay in starting the animation when the software code is executed in the browser.

7. The method of claim 1, wherein the master duration is associated with a total animation including all animations of elements in the plurality of elements.

8. The method of claim 1, further comprising:
receiving an input specifying a keyframe in a second layer included in the master layer, the second layer being associated with a second element in the plurality of elements to create an animation of the second element;
determining a keyframe value for the second layer based on the master duration;
determining a property value for the keyframe value for the second layer; and
generating software code specifying the calculated keyframe value and the determined property value for use in creating the animation of the second element.

9. A non-transitory computer-readable storage medium containing instructions for controlling a computer system to be operable to:
receive an input specifying a keyframe in a first layer included in a master layer to create an animation of a first element in a plurality of elements, the first layer being associated with the first element;
determine a master duration associated with the master layer, the master duration being applied to the plurality of elements;
determine a keyframe value for the first layer based on the master duration;
determine a property value for the keyframe value for the first layer; and
generate software code specifying the calculated keyframe value and the determined property value for use in creating the animation of the first element.

10. The non-transitory computer-readable storage medium of claim 9, further operable to hold the property value constant between a span of two keyframes in the first layer.

11. The non-transitory computer-readable storage medium of claim 9, wherein hold the property value constant comprises:
associate the property value with the keyframe in the two keyframes in the software code for creating the animation of the first element; and
associate the property value with the another keyframe in the two keyframes in the software code for creating the animation of the first element.

12. The non-transitory computer-readable storage medium of claim 9, further operable to display a visual indication for the span that the property value is being held constant between the two keyframes.

13. The non-transitory computer-readable storage medium of claim 9, wherein:
the animation of the first element is for a first duration,
the holding of the property value is for a second duration, and
the first duration and the second duration equal the master duration.

14. The non-transitory computer-readable storage medium of claim 9, wherein hold the property value constant simulates a delay in starting the animation when the software code is executed in the browser.

15. The non-transitory computer-readable storage medium of claim 9, wherein the master duration is associated with a total animation including all animations of elements in the plurality of elements.

16. The non-transitory computer-readable storage medium of claim 9, further operable to:
receive an input specifying a keyframe in a second layer included in the master layer, the second layer being associated with a second element in the plurality of elements to create an animation of the second element;
determine a keyframe value for the second layer based on the master duration;
determine a property value for the keyframe value for the second layer; and
generate software code specifying the calculated keyframe value and the determined property value for use in creating the animation of the second element.

17. An apparatus comprising:
one or more computer processors; and
a computer-readable storage medium comprising instructions for controlling the one or more computer processors to be operable to:
receive an input specifying a keyframe in a first layer included in a master layer to create an animation of a first element in a plurality of elements, the first layer being associated with the first element;
determine a master duration associated with the master layer, the master duration being applied to the plurality of elements;
determine a keyframe value for the first layer based on the master duration;
determine a property value for the keyframe value for the first layer; and
generate software code specifying the calculated keyframe value and the determined property value for use in creating the animation of the first element.

18. The apparatus of claim 17, further operable to hold the property value constant between a span of two keyframes in the first layer.

19. The apparatus of claim 17, wherein hold the property value constant comprises:
associate the property value with the keyframe in the two keyframes in the software code for creating the animation of the first element; and
associate the property value with the another keyframe in the two keyframes in the software code for creating the animation of the first element.

20. The apparatus of claim 17, further operable to display a visual indication for the span that the property value is being held constant between the two keyframes.
